(19) United States
(12) Patent Application Publication
(10) Pub. No.: US 2008/0180540 A1
(43) Pub. Date: Jul. 31, 2008

(54) CMOS image sensor with on-chip digital signal processing

(76) Inventors: Bum-Suk Kim, Seoul (KR); Jung-Chak Ahn, Yongin-Si (KR); Kyoung-Sik Moon, Hwaseong-si (KR); Eun-Gyu Lee, Yongin-Si (KR); Alexander Getman, Yongin-Si (KR)

Correspondence Address: LAW OFFICE OF MONICA H CHOI, P O BOX 3424, DUBLIN, OH, 430160204, US

(21) Appl. No.: 12/011,148

(22) Filed: Jan. 24, 2008

(30) Foreign Application Priority Data
Jan. 26, 2007 (KR) 2007-08318

(51) Int. Cl. H04N 5/228; H04N 5/335

(52) U.S. Cl. 348/222.1; 348/308; 348/E05.091; 348/E05.031

(57) ABSTRACT

A CMOS image sensor includes digital signal processing on-chip within the CMOS image sensor before being transmitted to an ISP (image signal processor) within an image sensor system. An on-chip digital processing unit is formed on a same one integrated circuit die with a pixel array and performs the steps of: performing a first set of at least one correction operation on the original digital signal to generate a corrected digital signal; formatting the corrected digital signal for the standard interface to generate a processed digital signal; and sending the processed digital signal to the ISP (image signal processor) via the standard interface.

### BACKGROUND OF THE INVENTION

This application claims priority under 35 USC §119 to Korean Patent Application No. 2007-08318, filed on Jan. 26, 2007 in the Korean Intellectual Property Office, the disclosure of which is incorporated herein in its entirety by reference.

### FIELD OF THE INVENTION

The present invention relates generally to image sensors, and more particularly, to digitally correcting an output signal of an image sensor such as a CMOS (complementary metal oxide semiconductor) image sensor before transmitting the output signal to an image signal processor (ISP) via a standard interface.

### BACKGROUND OF THE INVENTION

In general, an image sensor is classified into one of a charge coupled device (CCD) type and a CMOS (complementary metal oxide semiconductor) image sensor (CIS) type. The CMOS image sensor (hereinafter, referred to as the CIS) converts an optical image to electrical signals using photodiodes and CMOS devices such as MOSFETs (meal oxide semiconductor field effect transistors).

Compared to the CCD image sensor, the CIS is easier to drive and may adopt various scanning methods. Also, the circuit for processing signals output from the pixels is integrated into a single chip with the pixels such that product miniaturization is possible. Furthermore, with CMOS fabrication technology, manufacturing costs and power consumption may be reduced.

For example, FIG. 1 shows a CMOS image sensor system 100 according to the prior art. The CMOS image sensor system 100 includes a CMOS image sensor 102 with a pixel array 104 and an analog-to-digital converter (ADC) 106 fabricated as one integrated circuit die. The pixel array 104 generates analog signals from light of an image received at the pixel array 104. The ADC 106 converts such analog signals to digital signals that are output to an ISP (image signal processor) 108 via a standard interface 110.

The ISP 108 further processes the digital signals from the ADC 106 to generate image signals. The ISP 108 and the standard interface 110 are not fabricated as part of the integrated circuit die 102 of the pixel array 104 and the ADC 106.

Alternatively referring to FIG. 2 for the prior art, a CMOS image sensor system 150 includes a CMOS image sensor 152 having a pixel array 154, an analog-to-digital converter (ADC) 156, and an image signal processor (ISP) 158 fabricated as one integrated circuit die. The pixel array 154, the ADC 156, and the ISP 158 of FIG. 2 perform the same functions as those of the pixel array 104, the ADC 106, and the ISP 108, respectively, of FIG. 1. However, many vendors still manufacture a CMOS image sensor system with the ISP being fabricated as a separate integrated circuit chip.

In FIG. 1, the ISP 108 manages all further processing of the digital signals from the ADC 106. For example, the burden of signal processing arising from a defect of the CIS 102 lies with the ISP 108. However, when the ISP 108 is a common ISP and the characteristics of the CIS 102 vary according to different manufacturers, all digital signal processing by the common ISP 108 may not be efficient. Furthermore, in some cases, the common ISP 108 does not have a function for accounting for a defect characteristic of the CIS 102.

### SUMMARY OF THE INVENTION

Accordingly, a CMOS image sensor according to the present invention includes digital signal processing on-chip within the CMOS image sensor before being transmitted to an ISP (image signal processor).

An image sensor system according to an aspect of the present invention includes an ISP (image signal processor) for generating an image signal for an image and a standard interface. The image sensor system further includes an image sensor having a pixel array, an ADC (analog-to-digital converter), and an on-chip digital processing unit.

The image sensor generates an analog signal from photoelectron charge generated from light of the image received at the pixel array. The ADC converts the analog signal into an original digital signal. The on-chip digital processing unit is formed on a same one integrated circuit die with the pixel array and the ADC. In addition, the on-chip digital processing unit includes a data processor and a memory device.

The memory device has sequences of instructions stored thereon, and execution of the sequences of instructions by the data processor causes the data processor to perform the steps of:

performing a first set of at least one correction operation on the original digital signal to generate a corrected digital signal;

formatting the corrected digital signal for the standard interface to generate a processed digital signal; and

sending the processed digital signal to the ISP (image signal processor) via the standard interface.

In an example embodiment of the present invention, the ISP and the standard interface are fabricated on another integrated circuit die that is separate from the integrated circuit die of the pixel array.

In a further embodiment of the present invention, execution of the sequences of instructions by the data processor causes the data processor to further perform the steps of:

characterizing at least one fault characteristic of the pixel array;

storing information related to the at least one fault characteristic of the pixel array; and

performing correction to the original digital signal according to the stored information related to the at least one fault characteristic of the pixel array to generate the corrected digital signal.

In another embodiment of the present invention, the ISP performs a second set of correction operations, different from the first set of correction operations, on the processed digital signal to generate an image signal.

In an alternative embodiment of the present invention, the ISP also performs the first set of correction operations on the processed digital signal to generate an image signal.

The present invention may be used to particular advantage when the image sensor is a CMOS (complementary metal oxide semiconductor) image sensor. However, the present invention may be practiced with other types of image sensors.

In this manner, part of the burden of digital signal processing is shifted to the image sensor from the ISP for more efficiency. For example, when the digital signal processing is related to a defect characteristic of the pixel array, characterization of the defect and processing of the digital signal according to such defect characteristic may be more efficiently carried out at the image sensor.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of an image sensor system having a conventional CMOS image sensor, according to the prior art;

FIG. 2 is a block diagram of a conventional CMOS image sensor including a whole ISP (image signal processor), according to the prior art;

FIG. 3 is a block diagram of an image sensor system having a CMOS image sensor with a digital processing unit, according to an embodiment of the present invention;

FIG. 4 is a block diagram of the digital processing unit of FIG. 3, according to an embodiment of the present invention;

FIG. 5 is a block diagram of an image signal processor in FIG. 3, according to an embodiment of the present invention;

FIG. 6 shows a flowchart of steps during operation of the digital processing unit of FIGS. 3 and 4, according to an embodiment of the present invention;

FIG. 7 shows a block diagram of functional modules implemented by the digital processing unit of FIG. 4, according to an example embodiment of the present invention;

FIG. 8A shows a flowchart of steps during operation of the ISP of FIGS. 3 and 5, according to an embodiment of the present invention;

FIG. 8B shows a flowchart of steps during operation of the ISP of FIGS. 3 and 5, according to another embodiment of the present invention; and

FIG. 9 shows a flowchart of steps during operation of the digital processing unit of FIGS. 3 and 4 for processing of a digital signal according to defect characteristics of a pixel array, according to an embodiment of the present invention.

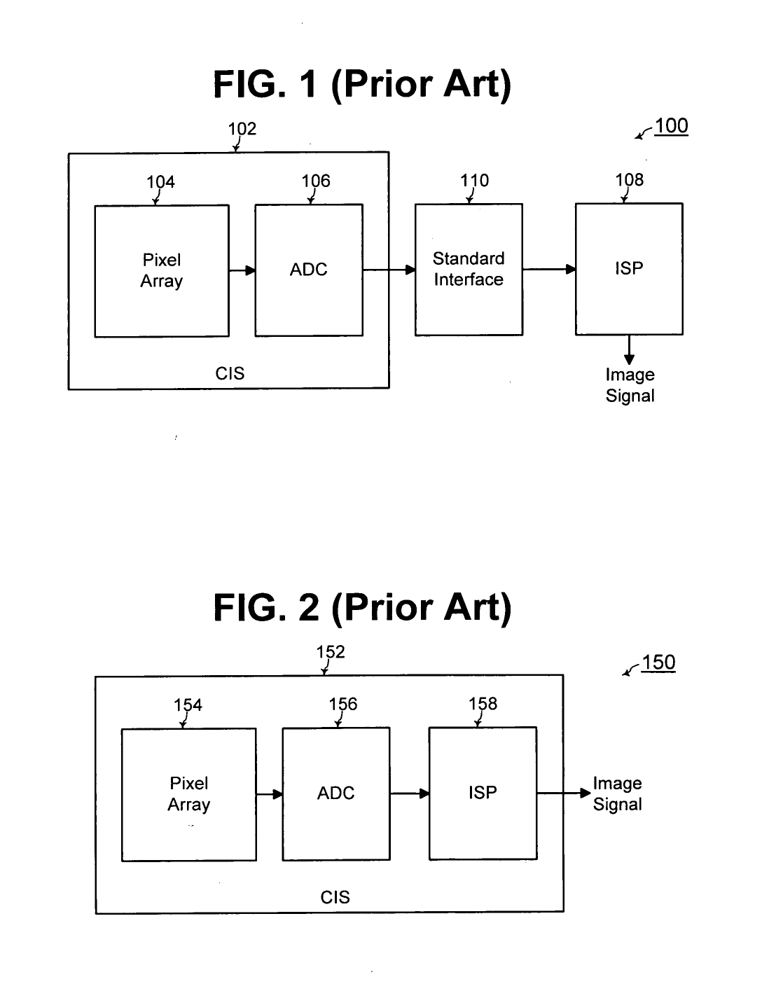

The figures referred to herein are drawn for clarity of illustration and are not necessarily drawn to scale. Elements having the same reference number in FIGS. 1, 2, 3, 4, 5, 6, 7, 8A, 8B, and 9 refer to elements having similar structure and/or function.

### DETAILED DESCRIPTION OF THE INVENTION

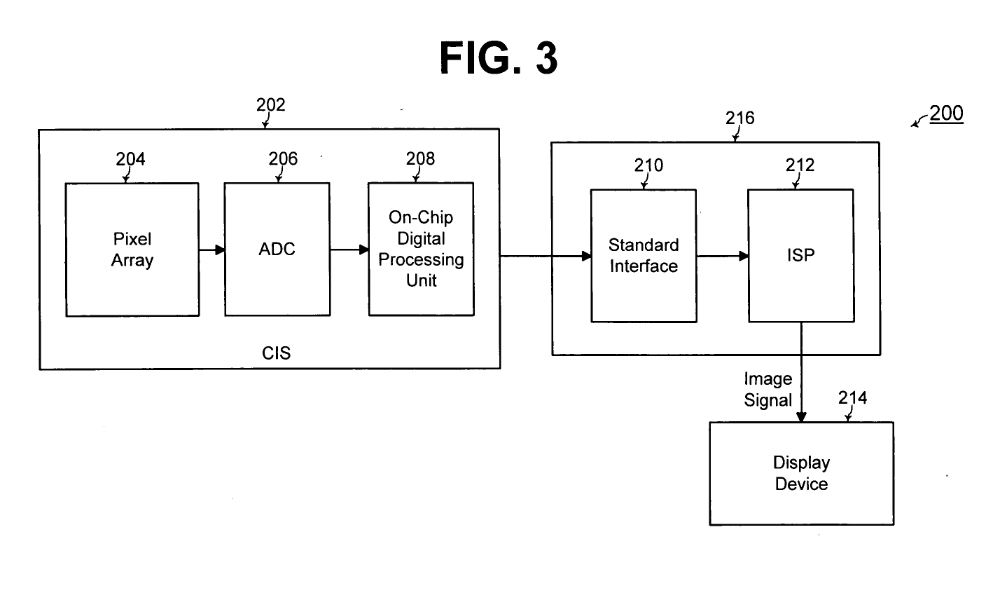

FIG. 3 shows a block diagram of an image sensor system 200 having a CMOS (complementary metal oxide semiconductor) image sensor 202 according to an embodiment of the present invention. The CMOS image sensor 202 includes a pixel array 204, an analog-to-digital converter (ADC) 206, and an on-chip digital processing unit 208. In one embodiment of the present invention, the pixel array 204, the ADC 206, and the digital processing unit 208 are fabricated as one integrated circuit die.

In addition, the image sensor system 200 includes a standard interface 210, an ISP (image signal processor) 212, and a display device 214. In one embodiment of the present invention, the standard interface 210 and the ISP 212 are fabricated as another integrated circuit die 216 that is separate from the integrated circuit die having the pixel array 204.

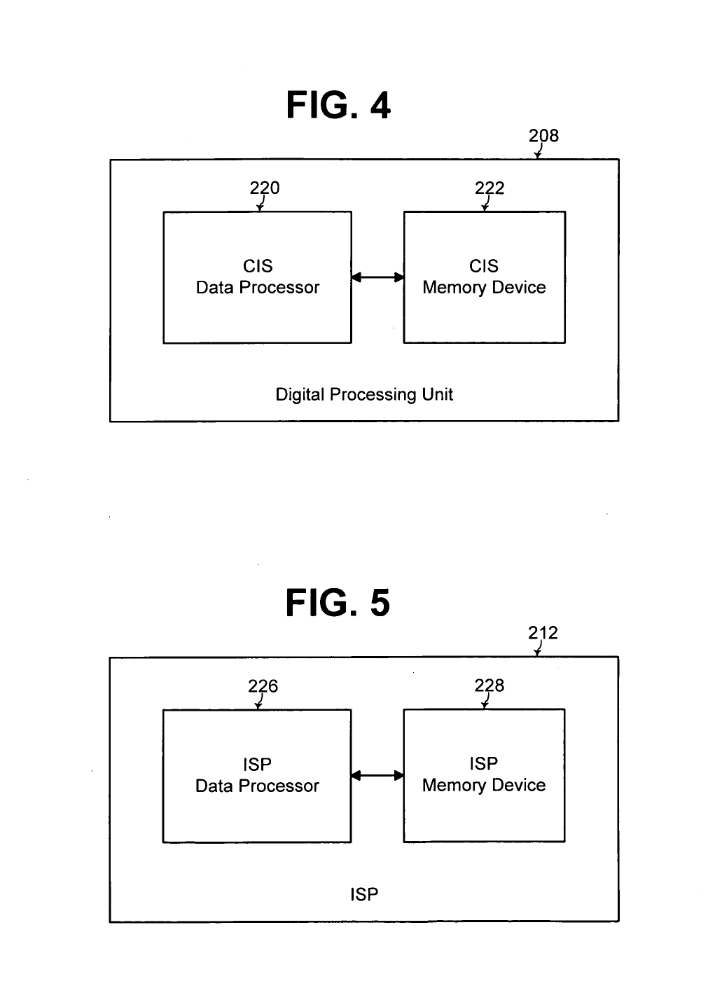

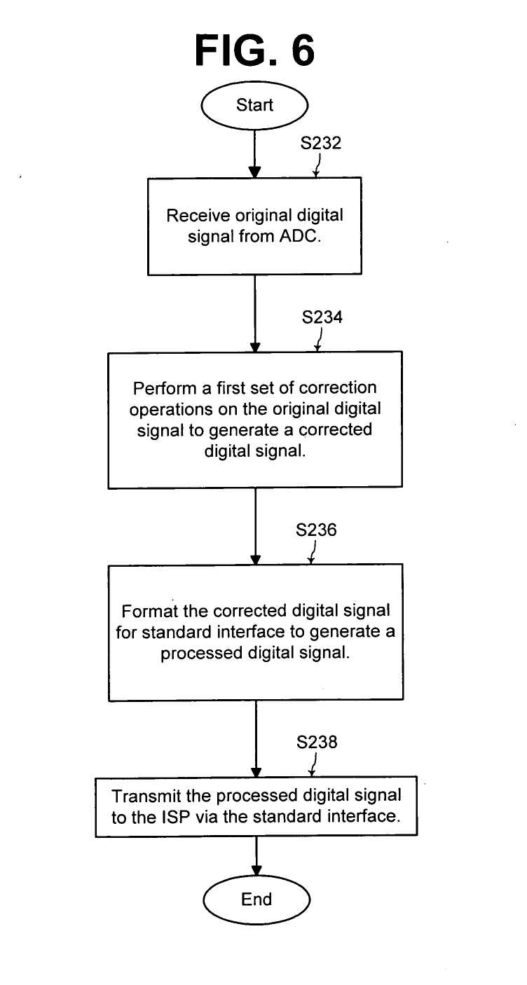

FIG. 4 shows a block diagram of the on-chip digital processing unit 208 of FIG. 3 according to an embodiment of the present invention. The on-chip digital processing unit 208 includes a CIS (CMOS image sensor) data processor 220 and a CIS (CMOS image sensor) memory device 222. The CIS memory device 222 has sequences of instructions (i.e., software) stored thereon, and execution of such sequences of instructions by the CIS data processor 220 causes the CIS data processor 220 to perform the steps of FIGS. 6, 7, and 9 according to an embodiment of the present invention.

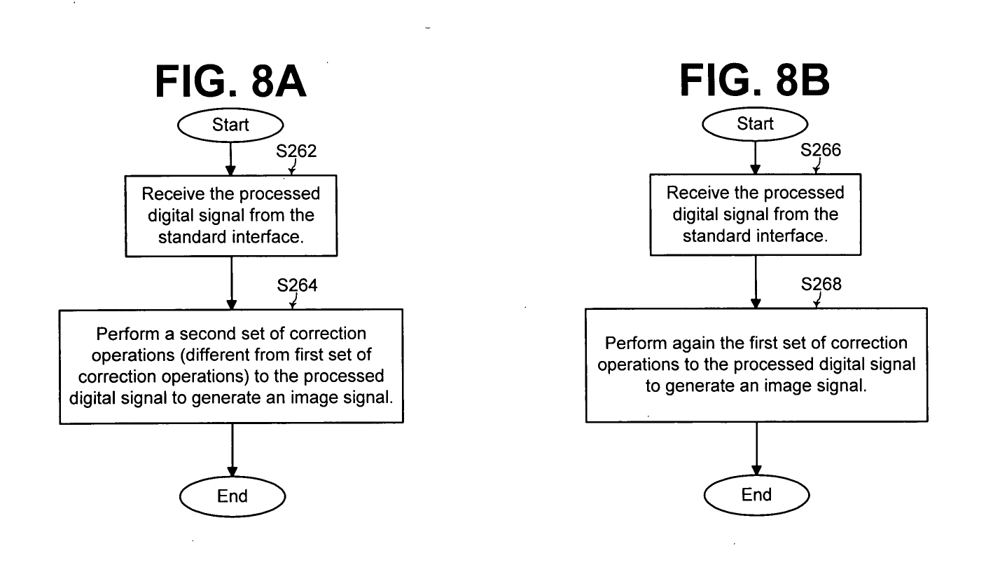

FIG. 5 shows a block diagram of the ISP 212 of FIG. 3 according to an embodiment of the present invention. The ISP 212 includes an ISP data processor 226 and an ISP memory device 228. The ISP memory device 228 has sequences of instructions (i.e., software) stored thereon, and execution of such sequences of instructions by the ISP data processor 226 causes the ISP data processor 226 to perform the steps of FIG. 8A or 8B according to an embodiment of the present invention.

FIG. 6 shows a flow-chart of steps performed by the on-chip digital processing unit 208 during operation of the image sensor system 200 of FIG. 3, according to an embodiment of the present invention. Referring to FIGS. 3 and 6, the pixel array 204 generates analog signals corresponding to the intensity of light received at the pixel array 204 from an image. Such analog signals are converted to original digital signals by the ADC 206. The CIS data processor 220 receives such original digital signals generated by the ADC 206 (step S232 of FIG. 6).

The CIS data processor 220 then performs a first set of correction operations on the original digital signals from the ADC 206 to generate corrected digital signals (step S234 of FIG. 6). The CIS data processor 220 subsequently formats the corrected digital signals for the standard interface 210 to generate processed digital signals (step S236 of FIG. 6). The CIS data processor 220 then transmits the processed digital signals to the ISP 212 via the standard interface 210 (step S238 of FIG. 6).

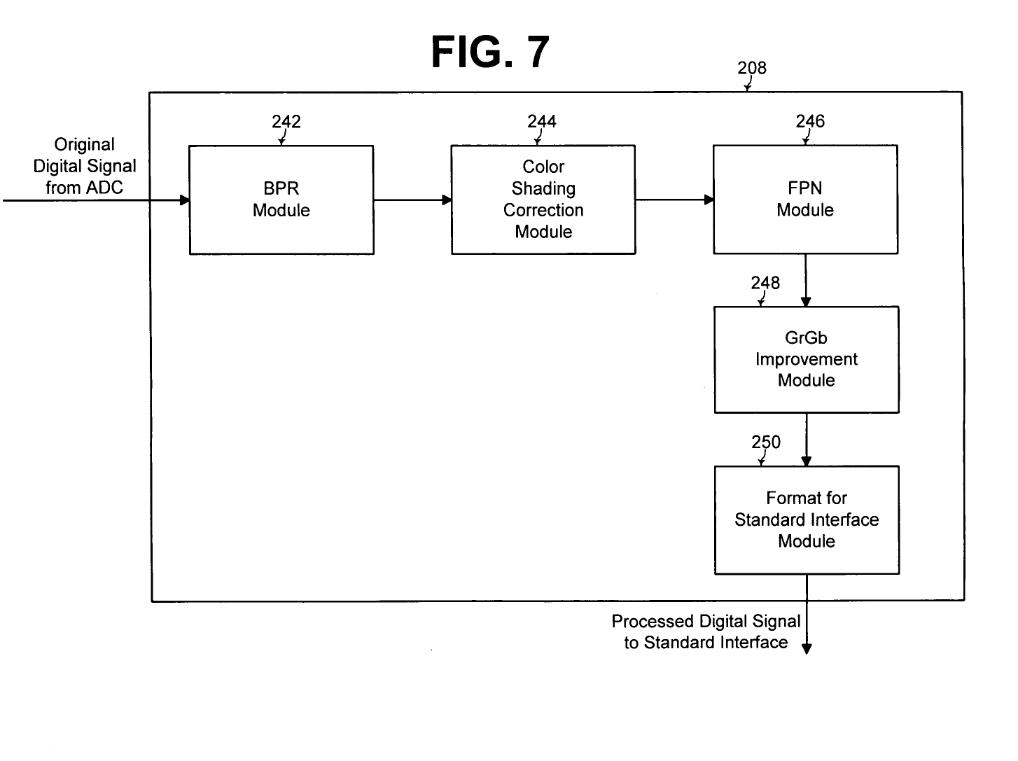

FIG. 7 illustrates an example of the first set of correction operations implemented as software modules executed by the CIS data processor 220 in the on-chip digital processing unit 208 on the original data signals from the ADC 206 to generate the corrected digital signals (step S234 of FIG. 6). Referring to FIG. 7, the digital processing unit 208 includes a BPR (bad pixel replacement) module 242, a color shading correction module 244, an FPN (fixed pattern noise) module 246, a GrGb improvement module 248, and a format for standard interface module 250.

The order of the modules 242, 244, 246, and 248 as performed by the CIS data processor 220 is not limited in the present invention. In addition, the present invention is practiced with the on-chip digital processing unit 208 including at least one of the modules 242, 244, 246, and 248. Thus, the present invention may be practiced with some of the modules 242, 244, 246, and 248 not being included in the on-chip digital processing unit 208.

The BPR (bad pixel replacement) module 242 processes the original digital signal from the ADC 206 to correct for bad pixels of the pixel array 204. More specifically, the BPR module 242 detects for any defective pixel by scanning the original digital signal from the ADC 206 and replaces data corresponding to such defective pixel with new digital signals generated using digital signals of neighboring pixels of the defective pixel. Operation of the BPR module 242 may be similar to white defect correction performed by the ISP 212. However, operation of the BPR module ISP 212 may vary according to the manufacturer.

Correction for a bad pixel in a pixel array of an image sensor, generally and individually, is known to one of ordinary skill in the art of image sensors. Thus, a detailed description of the BPR module 242 is omitted herein.

The color shading correction module 244 corrects for shading error occurring when a chief ray angle (CRA) of a module lens (not shown) is increased due to a limit in the size of a camera module (not shown) including the CIS 202 such that the surrounding light is decreased. In addition, the shading error may occur when an infrared (IR) cut filter is used for a high CRA lens and may be further deteriorated when a color temperature is low.

The color shading correction module 244 corrects for such shading error by increasing a gain value from a center of the captured image to the periphery of the image. Also, when the image according to the amount of light is presented in a 3D (three-dimensional) format, since the light amount increases at the center portion, the value of a function at the center is high while the value at the periphery is low. Thus, a method of obtaining an inverse function of the 3D graph and multiplying an input image by the obtained inverse function may be used by the color shading correction module 244.

Correction for shading error in an image of an image sensor, generally and individually, is known to one of ordinary skill in the art of image sensors. Thus, a detailed description of the color shading correction module 244 is omitted herein.

The FPN module 246 removes or reduces noise of a fixed pattern in the image captured by the pixel array 204. The FPN (fixed pattern noise) includes a column fixed pattern noise and a row fixed pattern noise. To remove such FPN, the FPN module 246 may use 2D (two-dimensional) filtering. For example, the FPN module 246 may use at least one of a median filter, a max and min filter, a midpoint filter, a band reject filter, a band pass filter, and a notch filter.

Correction for fixed pattern noise in an image sensor, generally and individually, is known to one of ordinary skill in the art of image sensors. Thus, a detailed description of the FPN module 246 is omitted herein.

The GrGb improvement module 248 corrects for a difference between Gr and Gb color components in advance of the ISP 212. When the digital processing unit 208 is able to control the gain for each of R(red), Gr, Gb, and B(blue) color components and each of the image grids for a captured image, the digital processing unit 208 not only corrects for the shading error by controlling each gain, but also corrects for the GrGb difference from the GrGb improvement module 248.

Correction for such a difference between Gr and Gb color components, generally and individually, is known to one of ordinary skill in the art of image sensors. Thus, a detailed description of the GrGb improvement module 248 is omitted herein.

In this manner, the original digital signals from the ADC 206 are processed through at least one of the modules 242, 244, 246, and 248 to generate the corrected digital signals. The digital processing unit 208 further includes a format for standard interface module 250 that formats such corrected digital signals to generate processed digital signals to be transmitted to the standard interface 210. Such corrected digital signals may be formatted to a form that is more suitable for the standard interface 210.

The present invention may be practiced with or without the format for standard interface module 250. For example, the present invention may be practiced without the format for standard interface module 250 if the standard interface is designed to handle the format of the corrected digital signals processed through the modules 242, 244, 246, and 248.

Referring to FIGS. 3 and 8A, the ISP 212 then receives such processed digital signals from the digital processing unit 208 via the standard interface 210 (step S262 of FIG. 8A). The ISP 212 then performs a second set of correction operations to such processed digital signals to generate image signals (step S264 of FIG. 8A). For example, the ISP 212 may perform various functions of white defect correction, RGB shading, RGB interpolation, color correction, and noise reduction, as individually known to one of ordinary skill in the art.

In one embodiment of the present invention, the second set of correction operations performed by the ISP 212 are different from the first set of correction operations performed by the digital processing unit 208. In that case, much of the burden of data processing is shifted from the ISP 212 to the CIS device 202. In addition, the vendor of the ISP 212 may vary and include different correction operations in the ISP 212. Including correction operations in the digital processing unit 208 of the CIS device 202 ensures that such correction operations will be performed.

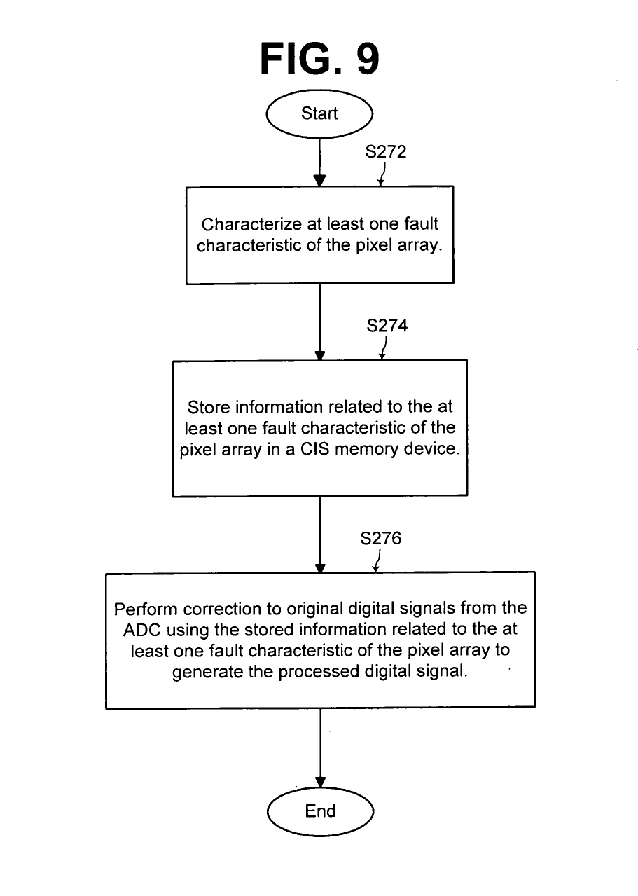

In addition, such an embodiment of FIG. 8A is especially amenable when the digital processing unit 208 performs correction according to a fault/defect characteristic of the pixel array 204. FIG. 9 shows a flow-chart of steps performed by the digital processing unit 208 that is implemented according to the block diagram of FIG. 4 for performing such a correction. In that case, execution of the sequences of instructions stored in the CIS memory device 222 by the CIS data processor 220 causes the CIS data processor 220 to perform the steps of FIG. 9 according to an embodiment of the present invention.

The CIS data processor 220 analyzes the original digital signals from the ADC 206 to determine at least one fault characteristic of the pixel array 204 (step S272 of FIG. 9). The CIS data processor 220 then stores such fault characteristic of the pixel array 204 in the CIS memory device 222 (step S274 of FIG. 9). The CIS data processor 220 then performs correction to original digital signals from the ADC 206 using the fault characteristic of the pixel array 204 as stored in the CIS memory device 222 to generate the processed digital signals for the ISP 212 (step S276 of FIG. 9).

The steps S272 and S274 of FIG. 9 may be performed during testing of the CIS device 202 before the CIS device 202 is assembled into the image sensor system 200. For example, the CIS device 202 may be fabricated by one manufacturer, and the ISP 212 may be fabricated by another manufacturer. In that case, steps S272 and S274 may be performed during a test process during manufacture of the CIS device 202. Also in that case, just step S276 of FIG. 9 is performed by the CIS data processor 220 using the fault characteristic stored in the CIS memory device 222 after the CIS device 202 is incorporated into the image sensor system 200.

FIG. 8B illustrates a flowchart for the embodiment of the ISP 212 performing a same set of correction operations as the digital processing unit 208. In that case, the ISP 212 receives the processed digital signals from the digital processing unit 208 via the standard interface 210 (step S266 of FIG. 8B). The ISP 212 then performs again the first set of correction operations to such processed digital signals to generate image signals (step S268 of FIG. 8B).

In that case, the correction operations are performed twice for ensuring proper digital correction and enhancement. Such a situation of FIG. 8B may occur because different vendors of the ISP 212 may include different correction operations within the ISP 212. Some vendors of the ISP 212 may include the correction operations already performed by the digital processing unit 208.

The present invention may also be practiced when both FIGS. 8A and 8B apply within the image sensor system 200 with a subset of the correction operations being performed only within the digital processing unit 208 or the ISP 212 and with another subset of the correction operations being performed within both the digital processing unit 208 and the ISP 212. In any case, the image signals generated from the ISP 212 are used for being displayed on a display device 214 in FIG. 3.

While the present invention has been particularly shown and described with reference to exemplary embodiments thereof, it will be understood by those of ordinary skill in the art that various changes in form and details may be made therein without departing from the spirit and scope of the present invention as defined by the following claims.

The present invention is limited only as defined in the following claims and equivalents thereof.

What is claimed is:

1. An image sensor, comprising:
a pixel array for generating an analog signal from photoelectron charge generated from light received at the pixel array;
an ADC (analog-to-digital converter) for converting the analog signal into an original digital signal; and
an on-chip digital processing unit formed on a same one integrated circuit die with the pixel array, the on-chip digital processing unit including:
a data processor; and
a memory device having sequences of instructions stored thereon, wherein execution of the sequences of instructions by the data processor causes the data processor to perform the steps of:
performing a first set of at least one correction operation on the original digital signal to generate a corrected digital signal;
formatting the corrected digital signal for a standard interface to generate a processed digital signal; and
sending the processed digital signal to an off-chip ISP (image signal processor) via the standard interface.

2. The image sensor of claim 1, wherein the pixel array, the ADC, and the on-chip digital processing unit are fabricated on said same one integrated circuit die.

3. The image sensor of claim 1, wherein the ISP and the standard interface are fabricated on another integrated circuit die that is separate from said integrated circuit die of the pixel array.

4. The image sensor of claim 1, wherein execution of the sequences of instructions by the data processor causes the data processor to further perform the steps of:
characterizing at least one fault characteristic of the pixel array;
storing information related to the at least one fault characteristic of the pixel array; and
performing correction to the original digital signal according to the stored information related to the at least one fault characteristic of the pixel array to generate the corrected digital signal.

5. The image sensor of claim 1, wherein the ISP performs a second set of correction operations, different from the first set of correction operations, on the processed digital signal to generate an image signal.

6. The image sensor of claim 1, wherein the ISP also performs said first set of correction operations on the processed digital signal to generate an image signal.

7. The image sensor of claim 1, wherein the image sensor is a CMOS (complementary metal oxide semiconductor) image sensor.

8. An image sensor, comprising:
a pixel array for generating an analog signal from photoelectron charge generated from light received at the pixel array;
an ADC (analog-to-digital converter) for converting the analog signal into an original digital signal; and
an on-chip digital processing unit formed on a same one integrated circuit die with the pixel array, the on-chip digital processing unit including:
means for performing a first set of at least one correction operation on the original digital signal to generate a corrected digital signal;
means for formatting the corrected digital signal for a standard interface to generate a processed digital signal; and
means for sending the processed digital signal to an off-chip ISP (image signal processor) via the standard interface.

9. The image sensor of claim 8, wherein the pixel array, the ADC, and the on-chip digital processing unit are fabricated on said same one integrated circuit die.

10. The image sensor of claim 8, wherein the ISP and the standard interface are fabricated on another integrated circuit die that is separate from said integrated circuit die of the pixel array.

11. The image sensor of claim 8, wherein the on-chip digital processing unit includes:
means for characterizing at least one fault characteristic of the pixel array;
means for storing information related to the at least one fault characteristic of the pixel array; and
means for performing correction to the original digital signal according to the stored information related to the at least one fault characteristic of the pixel array to generate the corrected digital signal.

12. The image sensor of claim 8, wherein the ISP performs a second set of correction operations, different from the first set of correction operations, on the processed digital signal to generate an image signal.

13. The image sensor of claim 8, wherein the ISP also performs said first set of correction operations on the processed digital signal to generate an image signal.

14. The image sensor of claim 8, wherein the image sensor is a CMOS (complementary metal oxide semiconductor) image sensor.

15. An image sensor system, comprising:
an ISP (image signal processor) for generating an image signal for an image;
a standard interface; and
an image sensor including:
a pixel array for generating an analog signal from photoelectron charge generated from light of the image received at the pixel array;
an ADC (analog-to-digital converter) for converting the analog signal into an original digital signal; and
an on-chip digital processing unit formed on a same one integrated circuit die with the pixel array, the on-chip digital processing unit including:
a data processor; and
a memory device having sequences of instructions stored thereon, wherein execution of the sequences of instructions by the data processor causes the data processor to perform the steps of:
performing a first set of at least one correction operation on the original digital signal to generate a corrected digital signal;
formatting the corrected digital signal for the standard interface to generate a processed digital signal; and
sending the processed digital signal to the ISP (image signal processor) via the standard interface.

16. The image sensor system of claim 15, wherein the pixel array, the ADC, and the on-chip digital processing unit are fabricated on said same one integrated circuit die.

17. The image sensor system of claim 15, wherein the ISP and the standard interface are fabricated on another integrated circuit die that is separate from said integrated circuit die of the pixel array.

18. The image sensor system of claim 15, wherein execution of the sequences of instructions by the data processor causes the data processor to further perform the steps of:
characterizing at least one fault characteristic of the pixel array;
storing information related to the at least one fault characteristic of the pixel array; and
performing correction to the original digital signal according to the stored information related to the at least one fault characteristic of the pixel array to generate the corrected digital signal.

19. The image sensor system of claim 15, wherein the ISP performs a second set of correction operations, different from the first set of correction operations, on the processed digital signal to generate an image signal.

20. The image sensor system of claim 15, wherein the ISP also performs said first set of correction operations on the processed digital signal to generate an image signal.
